(19) United States
(12) Patent Application Publication
(10) Pub. No.: US 2017/0349416 A1
(43) Pub. Date: Dec. 7, 2017

(54) Jack Stand with Dual Column Support

(71) Applicants: Louis Joseph Sigouin, Arborfield (CA); Daniel Steven Edwards, Arborfield (CA)

(72) Inventors: Louis Joseph Sigouin, Arborfield (CA); Daniel Steven Edwards, Arborfield (CA)

(21) Appl. No.: 15/608,303

(22) Filed: May 30, 2017

Related U.S. Application Data
(60) Provisional application No. 62/344,116, filed on Jun. 1, 2016.

(51) Int. Cl. B66F 5/04

(52) U.S. Cl. CPC B66F 5/04; B66F 2700/052

(57) ABSTRACT

A jack stand includes a base having a jacking surface which receives a jack thereon, in which the jack has a main body and a lifting head which can be jacked up. Two support columns extend perpendicularly upward from the base parallel to and spaced apart from one another by a fixed lateral spacing to receive the jack therebetween. A jack body is slidably supported along the two columns and includes a jacking surface on a bottom side thereof so as to be arranged to operatively receive the jack between the two jacking surfaces of the jack body and the base respectively such that operation of the jack displaces the jack body relative to the base. A jack post, upon which an object to be jacked is supported, is slidably supported on the jack body to be adjustable in height independently of a height of the jack body.

This application claims the benefit under 35 U.S.C. 119(e) of U.S. provisional application Ser. No. 62/344,116, filed Jun. 1, 2016.

### FIELD OF THE INVENTION

The present invention relates to a jack stand having a base and a jack body which is movable relative to the base and which receives a conventional jack therein such that operation of the jack between the jack body and the base raises the jack body relative to the base. More particularly the present invention relates to a jack stand in which i) the jack body is supported for height adjustable sliding relative to the base by a pair of support column receiving the convention jack therebetween, and/or ii) a jack post defining an upper surface for supporting the object to be lifted thereon is height adjustable relative to the jack body independently of operation of the conventional jack to lift the jack body relative to the base.

### BACKGROUND

Various types of jack stands are known for receiving a conventional jack, for example a hydraulic jack, therein for jacking a jack body relative to a base of the jack stand. U.S. Pat. No. 5,915,672 by Dickey discloses one such example of a jack stand in which the hydraulic jack is supported on a base plate of the jack stand for selectively raising a sliding post that defines the jack body relative to the base plate. The single post and supporting frame structure which supports a sleeve for guiding the vertical sliding of the post provide limited support during operation and are not well suited for lifting heavy equipment, for example agricultural equipment including tractors and the like or various construction equipment.

### SUMMARY OF THE INVENTION

According to one aspect of the invention there is provided a jack stand for use with a jack having a main body and a lifting head which can be jacked up relative to the main body, the jack stand comprising:

a base arranged to be supported on a ground surface;

two support columns extending perpendicularly upward from the base in fixed relation to one another and the base so as to be parallel to one another and spaced apart from one another by a fixed lateral spacing;

a jack body supported on the two columns for sliding movement along the two columns;

a jacking surface on a bottom side of the jack body laterally between the two columns, the jacking surface being parallel to and spaced directly above a corresponding jacking surface on the base laterally between the two columns so as to be arranged to operatively receive the jack between the two jacking surfaces of the jack body and the base respectively such that operation of the jack displaces the jack body relative to the base; and an upper surface on a top side of the jack body for supporting an object to be lifted thereon.

The dual support columns provide much greater lateral support and stability to a heavy object to be lifted during a lifting operation as compared to prior art jack stands limited to a single sliding support. The balanced arrangement of two columns receiving the jack therebetween further enhances stability of the jack stand.

Preferably the jack body includes two cavities formed therein in which each cavity mates with a respective one of the two columns for relative sliding movement therebetween.

The jack stand may include two sleeves which matingly receive the two columns respectively for relative sliding movement, in which the two sleeves protrude downwardly below the jacking surface on the jack body.

Preferably each column includes a set of apertures formed therein at different heights along the column, in which each aperture of each column is aligned at a common height with a corresponding one of the apertures in the other column. In this instance the jack stand preferably further comprises a pair of pins adapted to be received within a selected pair of the apertures in the columns respectively to prevent downward movement of the jack body relative to the two columns at a selected one of a plurality of different heights along the columns.

Preferably the upper surface for supporting the object to be lifted therein is adjustable in height relative to the jack body. In this regard, the jack stand preferably further includes i) a jack post supported on the jack body which defines said upper surface on a top side thereof and which is supported at a laterally centered location between the two columns so as to be slidably adjustable in height relative to the jack body independently of a height of the jack body relative to the base according to operation of the jack, and ii) a retainer member operative relative to the jack body to selectively retain the jack post at a selected height relative to the jack body.

Preferably the base comprises a horizontal plate supporting both column thereon and which protrudes horizontally outward in all directions beyond each of the two columns supported thereon.

Preferably the two support columns are spaced apart in a lateral direction by said fixed lateral spacing, in which the base comprises a horizontal plate which has a length in a longitudinal direction perpendicular to said lateral direction which is greater than said fixed lateral spacing of the two support columns.

Preferably a plurality of gussets are connected between each support column and the base.

According to a second aspect of the present invention there is provided a jack stand for use with a jack having a main body and a lifting head which can be jacked up relative to the main body, the jack stand comprising:

a base arranged to be supported on a ground surface;

at least one support column extending perpendicularly upward from the base in fixed relation to the base;

a jack body supported on said at least one support column for sliding movement along said at least one support column;

a jacking surface on a bottom side of the jack body that is parallel to and spaced directly above a corresponding jacking surface on the base so as to be arranged to operatively receive the jack between the two jacking surfaces of the jack body and the base respectively such that operation of the jack displaces the jack body relative to the base;

a jack post supported on the jack body so as to be slidably adjustable in height relative to the jack body independently of a height of the jack body relative to the base according to operation of the jack;

a retainer member operative relative to the jack body to selectively retain the jack post at a selected height relative to the jack body;

an upper surface on a top side of the jack post for supporting an object to be lifted thereon.

The combination of a jack body which is height adjustable by operation of a jack received therein with a jack post that adjusts in height relative to the jack body independently of the operation of the jack greatly increases the overall range of heights that the jack stand can operate within.

### BRIEF DESCRIPTION OF THE DRAWINGS

One embodiment of the invention will now be described in conjunction with the accompanying drawings in which:

FIG. 1 is a first perspective view of the jack stand;

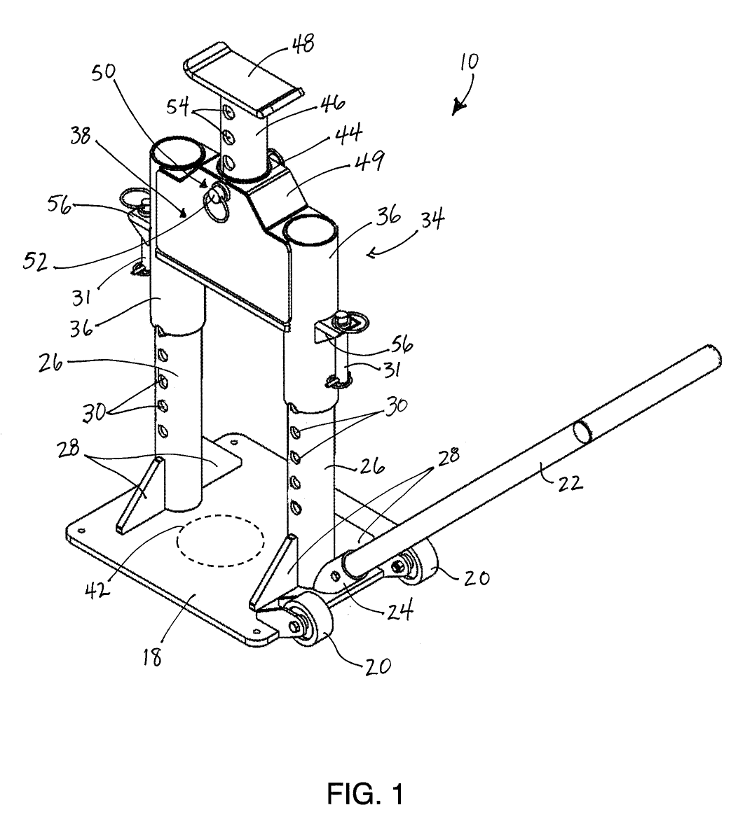

FIG. 2 is a second perspective view of the jack stand according to FIG. 1;

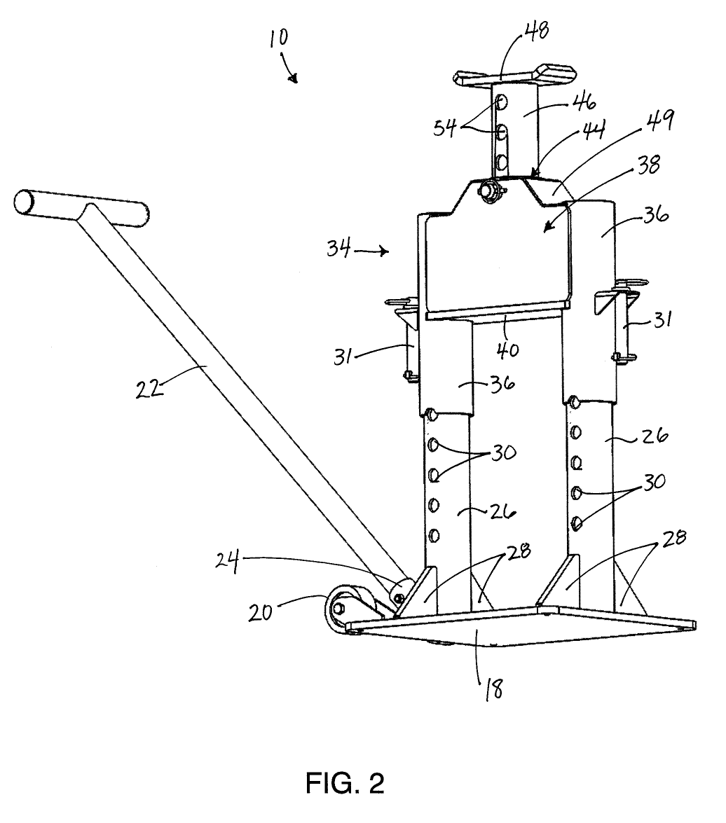

FIG. 3 is a vertical cross section of the jack body through a central axis of both columns and the jack post;

FIG. 4 is a perspective view of the jack body with a portion of the jack body shown removed for illustrative purposes; and

FIG. 5 is a side elevational view of the jack stand.

In the drawings like characters of reference indicate corresponding parts in the different figures.

### DETAILED DESCRIPTION

Referring to the accompanying figures there is illustrated a jack stand generally indicated by reference numeral 10. The jack stand is particularly suited for use with a conventional jack, for example a hydraulic jack 12 of the type including a main body 14 and a lifting head 16 which can be raised and lowered relative to the main body 14.

The jack stand 10 includes a base 18 comprising a rigid rectangular plate spanning horizontally at the bottom of the jack stand for being engaged upon a ground surface in operation. A pair of wheels 20 are rotatably supported at one end of the base plate for rotation about a common rolling axis. The wheels are positioned so as to be elevated above a bottom side of the base plate when the base plate is flat on the ground, however, tilting by upward lifting of the opposing second end of the base plate permits the wheels to engage the ground for rolling displacement along the ground.

A handle 22 is removably received within a socket 24 at the first end of the base plate to be centered between the wheels 20 to assist in tilting the jack stand about an axis of the wheels when engaging the wheels upon the ground for transport. The jack stand further includes two support columns 26 which extend perpendicularly upward from the base plate at spaced apart positions in a lateral direction across the base plate. In the illustrated embodiment, the support columns are round in cross section; however, in further embodiments, the support columns may be square or other polygonal shapes. The support columns 26 are fixed to the base plate by a welded connection.

In the illustrated embodiment, the columns are welded to the base plate from the top side of the base plate only.

In further embodiments however, an opening may be cut into the base plate in alignment with each support column such that the support column can be partially recessed into the base plate. In this instance, the columns are only partially recessed to provide clearance below each column to receive a weld bead between the bottom of the column and the bottom side of the base plate which remains non-protruding and flush with the bottom side of the plate. A second weld bead can also be provided about the full circumference of each column at the top side of the base plate.

A plurality of gussets 28 are connected between the bottom end of the support columns and the base plate to ensure the support columns remain at a fixed lateral spacing relative to one another on the base plate. The gussets are secured by welded connections to the columns and to the base plate.

A set of apertures 30 are provided at vertically spaced apart positions within each of the support columns such that each aperture of each column is aligned at a common height with a corresponding one of the apertures of the other column. Each aperture comprises a first opening in a front face of the corresponding column and a second opening in the opposing rear face of the corresponding column to receive a suitable retainer pin 31 within a selected aperture of each column so that the retainer pin extends fully through the column and protrudes outwardly from the opposing front and rear faces of the column. The front face and the rear face of each column are coplanar with the corresponding front face and rear face of the other column within respective laterally oriented planes.

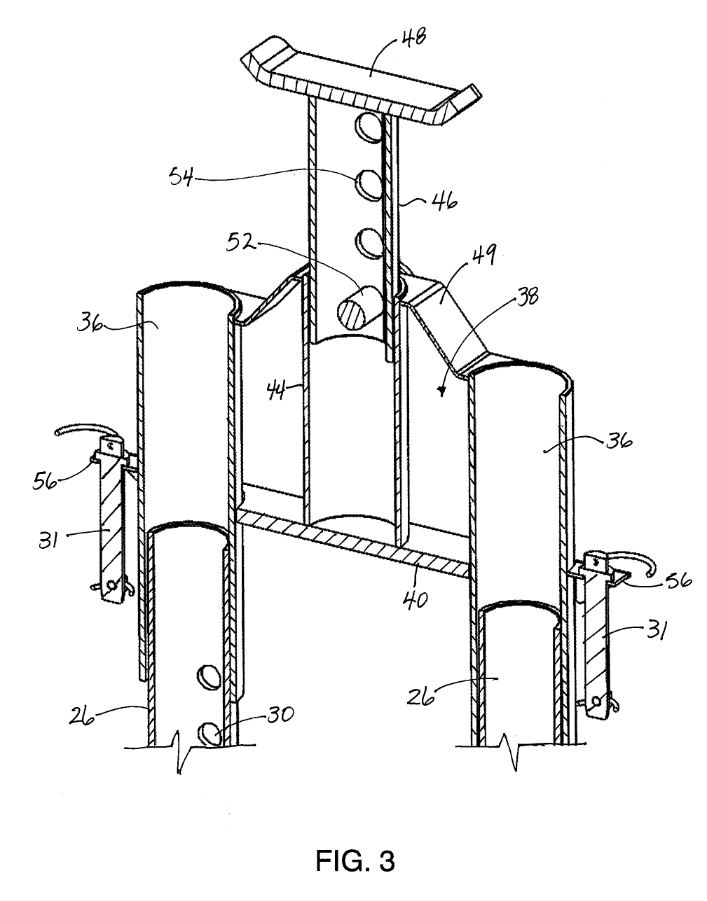

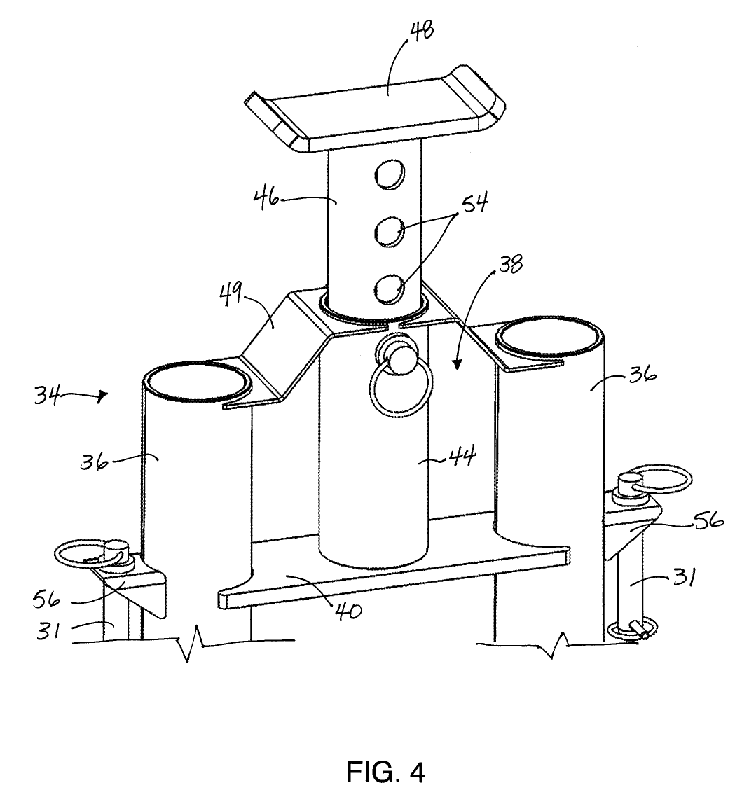

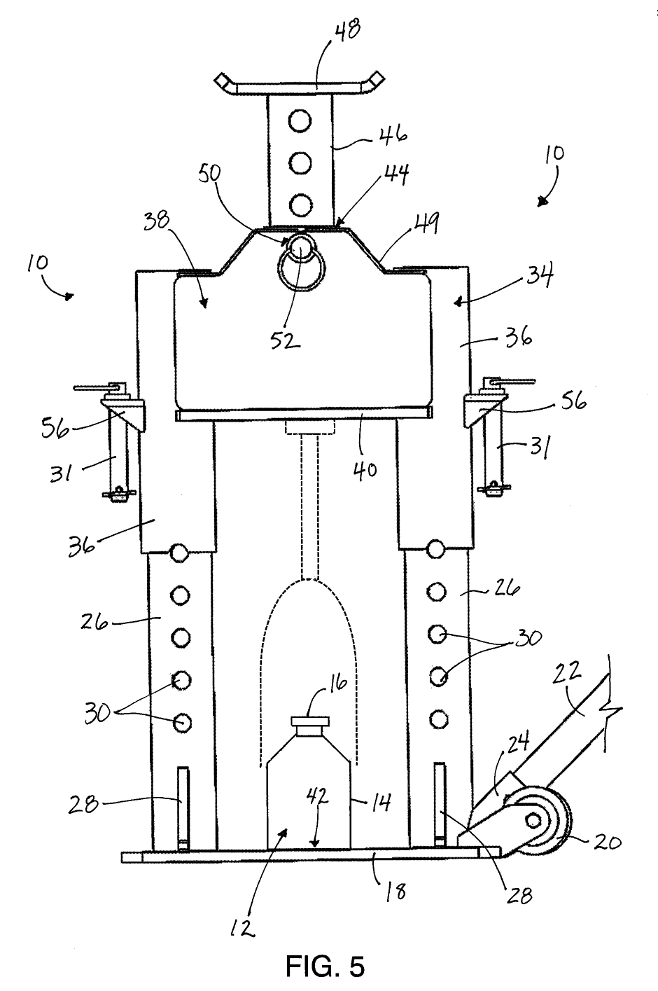

A jack body 34 is mounted for sliding movement along the two support columns 26 between a lowermost position shown in FIGS. 3 and 4, and an uppermost position shown in FIG. 5. The jack body 34 comprises two sleeves 36 that are round in cross section to define a respective pair of cavities within the jack body that receive respective ones of the two support columns slidably therein. The mating cross-sections ensure a close tolerance, vertical-sliding-only connection between the jack body and the two support columns 26.

The jack body 34 further includes a main body portion 38 comprising a parallel front and rear plates connected by fixed welding to span laterally between the two sleeves 36 at opposing from and rear sides of the jack body. A bottom plate 40 spans horizontally between the sleeves 36 and between the front and rear plates of the main body portion 38 at the bottom side of the main portion. The bottom plate 40 is spaced above the bottom ends of the two sleeves 36. The bottom ends of the two sleeves are aligned with one another within a common horizontal plane which is parallel to the base plate.

The bottom plate 40 defines a jacking surface on the bottom side thereof which is parallel and laterally centred between the two support columns, while being located directly above a, corresponding a jacking surface 42 defined by a portion of the upper surface of the base plate 18 at a laterally centred location between the two support columns. The two jacking surfaces are arranged to receive the jack 12 operatively therebetween in the lowermost position of the jack stand when the bottom ends of the two sleeves 36 of the jack body are engaged upon the gussets at the bottoms of the columns 32 respectively. The jack sits between the jacking surfaces in the lowermost position.

As the jack is operated to raise the lifting head 16 relative to the main body 14 thereof, the lifting head engages the jacking surface of the bottom plate 40 to raise the jack body 34 relative to the support columns on the base 18. As different apertures 30 in the two support columns become exposed below the jack body, the retainer pins 31 can be inserted into the uppermost exposed corresponding pair of apertures in the two columns once the jack body has been raised to the desired height. Releasing the jack 12 then only permits the jack body to be lowered onto the two retainer pins 31 protruding from opposing faces of the respective columns to maintain the jack body at the selected height relative to the base.

Blocks can be used to raised the jack while the jack body is supported on the retainer pins 31 to extend the overall jacking height enabled by the jack 12. The jack body can thus be lifted in stages along the full height of the columns using a small jack with a much smaller overall jacking height than the jacking height of the jack stand by periodically resting the jack body on different heights of retainer pins to allow more blocks to be added below the jack 12.

The jack body 34 further includes a centre tube 44 which is laterally centred between the two sleeves 36 and which is vertically oriented to be parallel to the two sleeves 36. The centre tube 44 has an outer diameter which fully spans the horizontal space between the front and rear plates at opposing front and rear sides of the jack body to formed a fixed connection therebetween, for example by welding. The centre tube 44 is thus joined in fixed connection to the two sleeves 36 by the front and rear plates at the front and rear sides of the jack body. A bottom end of the centre tube abuts the top side of the bottom plate that defines the jacking surface of the jack body thereon. The centre tube is round in cross-section and communicates openly through the top end of the jack body.

A top plate 49 encloses a top end of the jack body between the front and rear plates. The top end of the centre tube 44 is spaced upwardly above the top ends of the sleeves 36 such that the top plate is stepped in profile between the lower elevation of the top ends of the sleeves at laterally opposed ends of the top plate, and the higher elevation of the centre tube at the centre of the top plate. A round opening is formed centrally in the top plate 49 so that the centre tube is open at a top end through the round opening in the top plate.

A jack post 46 of round cross-section is matingly received within the centre tube to form a vertically slidable connection between the jack post and the centre sleeve of the jack body. The top end of the jack post 46 supports a top plate 48 thereon which is rectangular in shape and which is perpendicular to the vertical sliding axis of the centre sleeve. An upper surface of the top plate 48 defines a supporting surface upon which an object to be lifted can be engaged during lifting. The horizontal dimensions of the top plate 48 are greater than the opening within the centre sleeve such that the top plate cannot be slidably displaced downwardly beyond the top end of the centre sleeve.

A main aperture 50 communicates through opposing front and rear faces of the jack body adjacent the top end of the jack body in alignment with the centre sleeve 44 for receiving a respective retainer pin 52 selectively therein. A plurality of corresponding apertures communicates through the jack post at vertically spaced apart positions therealong. The apertures 54 in the jack post can be selectively aligned with the main aperture 50 in the jack body to enable the retainer pin 52 to be communicated through both the jack body and the jack post at any one of a plurality of different selected heights of the upper surface of the jack post relative to the jack body.

Two pin hangers 56 are mounted on the sleeves 36 respectively at laterally opposed sides the jack body. Each pin hanger comprises a protruding horizontal flange with an aperture therein which slidably receives a respective one of the retainer pins 31 for storage when not in use.

The jack stand 10 may be used individually or in pairs. When used in pairs, the two jack stands are typically provided at opposing sides, or opposing ends of an object to be lifted. Typically, the height of the jack post relative to the jack body is first selected independently of operation of the jack within the jack stand. Once the height of the upper surface of the jack post relative to the jack body has been selected and retained using the corresponding retainer pin 52, the jack can then be placed between the jacking surfaces of the jack body and the base respectively. Operation of the jack will cause the jack body to be lifted relative to the base by sliding movement of the jack body along the two support columns. When a desired height has been reached, the retainer pins 31 can be used to retain the jack body at the selected height by preventing downward sliding movement of the jack body along the support columns downwardly beyond the retainer pins 31. The jack can be removed from the jack stand once pinned. Accordingly, a single jack can be used for lifting two different jack stands sequentially if desired.

Since various modifications can be made in my invention as herein above described, and many apparently widely different embodiments of same made, it is intended that all matter contained in the accompanying specification shall be interpreted as illustrative only and not in a limiting sense.

1. A jack stand for use with a jack having a main body and a lifting head which can be jacked up relative to the main body, the jack stand comprising:
a base arranged to be supported on a ground surface;
two support columns extending perpendicularly upward from the base in fixed relation to one another and the base so as to be parallel to one another and spaced apart from one another by a fixed lateral spacing;
a jack body supported on the two columns for sliding movement along the two columns;
a jacking surface on the jack body laterally between the two columns, the jacking surface being parallel to and spaced directly above a corresponding jacking surface on the base laterally between the two columns so as to be arranged to operatively receive the jack between the two jacking surfaces of the jack body and the base respectively such that operation of the jack displaces the jack body relative to the base; and
an upper surface on a top side of the jack body for supporting an object to be lifted thereon.

2. The jack stand according to claim 1 wherein the jack body includes two cavities formed therein in which each cavity mates with a respective one of the two columns for relative sliding movement therebetween.

3. The jack stand according to claim 1 wherein each column includes a set of apertures formed therein at different heights along the column, each aperture of each column being aligned at a common height with a corresponding one of the apertures in the other column and wherein the jack stand further comprises a pair of pins adapted to be received within a selected pair of the apertures in the columns respectively to prevent downward movement of the jack body relative to the two columns at a selected one of a plurality of different heights along the columns.

4. The jack stand according to claim 1 wherein the upper surface for supporting the object to be lifted therein is adjustable in height relative to the jack body.

5. The jack stand according to claim 4 further comprising i) a jack post supported on the jack body which defines said upper surface on a top side thereof and which is supported at a laterally centered location between the two columns so as to be slidably adjustable in height relative to the jack body independently of a height of the jack body relative to the base according to operation of the jack, and ii) a retainer member operative relative to the jack body to selectively retain the jack post at a selected height relative to the jack body.

6. The jack stand according to claim 1 wherein the base comprises a horizontal plate supporting both column thereon and which protrudes horizontally outward in all directions beyond each of the two columns supported thereon.

7. The jack stand according to claim 1 wherein the two support columns are spaced apart in a lateral direction by said fixed lateral spacing and wherein the base comprises a horizontal plate which has a length in a longitudinal direction perpendicular to said lateral direction which is greater than said fixed lateral spacing of the two support columns.

8. The jack stand according to claim 1 further comprising a plurality of gussets connected between each support column and the base.

9. The jack stand according to claim 1 wherein the jack body includes two sleeves which matingly receive the two columns respectively for relative sliding movement, wherein the two sleeves protrude downwardly below the jacking surface on the jack body.

10. A jack stand for use with a jack having a main body and a lifting head which can be jacked up relative to the main body, the jack stand comprising:
a base arranged to be supported on a ground surface;
at least one support column extending perpendicularly upward from the base in fixed relation to the base;
a jack body supported on said at least one support column for sliding movement along said at least one support column;
a jacking surface on a bottom side of the jack body that is parallel to and spaced directly above a corresponding jacking surface on the base so as to be arranged to operatively receive the jack between the two jacking surfaces of the jack body and the base respectively such that operation of the jack displaces the jack body relative to the base;
a jack post supported on the jack body so as to be slidably adjustable in height relative to the jack body independently of a height of the jack body relative to the base according to operation of the jack;
a retainer member operative relative to the jack body to selectively retain the jack post at a selected height relative to the jack body;
an upper surface on a top side of the jack post for supporting an object to be lifted thereon.
